(19) United States
(12) Patent Application Publication
(10) Pub. No.: US 2025/0306649 A1
(43) Pub. Date: Oct. 2, 2025

(54) TOUCH PANEL ASSEMBLY

(71) Applicant: Acer Incorporated, New Taipei City (TW)

(72) Inventor: Yan-Lin KUO, New Taipei City (TW)

(73) Assignee: Acer Incorporated, New Taipei City (TW)

(21) Appl. No.: 18/986,465

(22) Filed: Dec. 18, 2024

(30) Foreign Application Priority Data
Mar. 29, 2024 (TW) 113112032

(51) Int. Cl. G06F 1/16

(52) U.S. Cl. CPC G06F 1/169

(57) ABSTRACT

A touch panel assembly is provided. The touch panel assembly comprises a base and a touch panel module. The touch panel module is disposed on the base, and includes a flexible sheet component, a circuit board, and a lever component. The flexible sheet component has opposing top and bottom surfaces. The circuit board is adhered to a middle adhesive portion of the top surface and has a trigger element. The lever component is adhered to a lower adhesive portion of the bottom surface. A lower non-adhesive portion of the top surface is at an opposite side to a position where the lever component is adhered to the lower adhesive portion. A pivot axis is formed between the lower non-adhesive portion and the middle adhesive portion. The flexible sheet component allows the lever component to swing along the pivot axis so as to contact the trigger element.

### TECHNICAL FIELD

This application claims the benefit of Taiwan application Serial No. 113112032, filed Mar. 29, 2024, the subject matter of which is incorporated herein by reference.

The invention relates in general to a touch panel assembly, and more particularly to a touch panel assembly used in a laptop computer.

### BACKGROUND

In the field of a touch panel, in order to prevent an upper surface of the touch panel that is protruded from hand-placed area for users from being mistakenly touched, a stopping structure is disposed to limit a switch element. Additionally, an elastic structure is disposed to support a circuit board and other structures of the touch panel. Since the elastic structure is normally screwed on a casing of the laptop computer, users usually need a tool when assembling or disassembling the laptop computer. Besides, a problem of poor size stability may easily occur to the stopping structure or the elastic structure, thereby negatively affecting a hand feel when pressing the touch panel.

Therefore, it has become a prominent task for the industries to make improvement on current products of the touch panel and to develop a lighter touch panel with better hand feel.

### SUMMARY

The invention is directed to a novel touch panel assembly able to achieve lightweight and reduce production cost on the premise that the touch panel assembly can complete the press triggering action.

According to one embodiment of the present invention, a touch panel assembly is provided. The touch panel assembly comprises a base and a touch panel module. The touch panel module is disposed on the base, and includes a flexible sheet component, a circuit board and a lever component. The flexible sheet component has opposing top and bottom surfaces. The circuit board is adhered to a middle adhesive portion of the top surface and has a trigger element. The lever component is adhered to a lower adhesive portion of the bottom surface. A lower non-adhesive portion of the top surface is at an opposite side to a position where the lever component is adhered to the lower adhesive portion. A pivot axis is formed between the lower non-adhesive portion and the middle adhesive portion. The flexible sheet component allows the lever component to swing along the pivot axis so as to contact the trigger element.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic 3D diagram of a touch panel assembly according to an embodiment of the present invention.

FIG. 2 is a side view of the touch panel assembly of FIG. 1.

FIGS. 3A to 3B are enlarged side views of local areas of the touch panel assembly of FIG. 2.

FIGS. 4A to 4B are schematic 3D diagrams of a flexible sheet component of a touch panel module of the touch panel assembly of FIG. 1.

FIG. 5A is an explosion diagram of the touch panel module of the touch panel assembly of FIG. 1.

FIG. 5B is a schematic assembly diagram of the touch panel module of the touch panel assembly of FIG. 1.

FIG. 6 is a schematic 3D diagram of a base of the touch panel assembly of FIG. 1.

### DETAILED DESCRIPTION

Detailed descriptions of each embodiment of the present invention are disclosed below with reference to accompanying drawings. Apart from the said detailed descriptions, any embodiments in which the present invention can be used as well as any substitutions, modifications or equivalent changes of the said embodiments are within the scope of the present invention, and the descriptions and definitions in the claims shall prevail. Moreover, generally known procedures or elements are not disclosed to avoid adding unnecessary restrictions to the present invention. Also, unless otherwise specified, element designations common to different drawings can be regarded as corresponding elements.

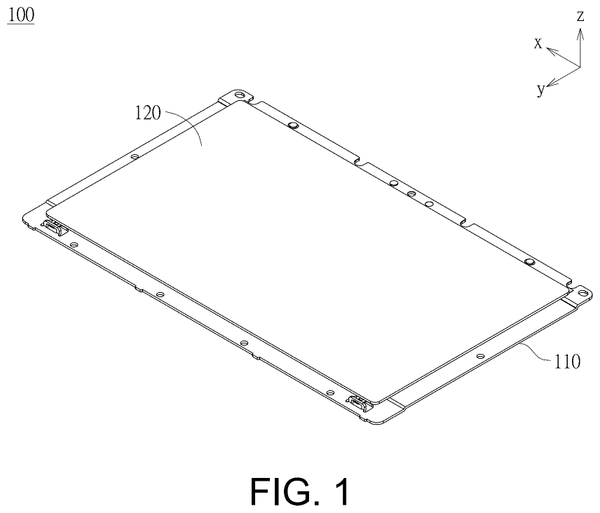

Referring to FIG. 1, a schematic 3D diagram of a touch panel assembly 100 according to an embodiment of the present invention is shown.

The touch panel assembly 100 is applicable to a laptop computer and has a touch sensing function by which the user can control the cursor or perform a pressing operation. The touch panel assembly 100 comprises a base 110 and a touch panel module 120. The touch panel module 120 is disposed on the base 110. The base 110 can be made of plastics or metal alloy and can be arranged on the part of a laptop computer generally known as C cover and D cover. By pressing the touch panel module 120, the user can activate relevant circuits (not illustrated) disposed therein to perform touch input.

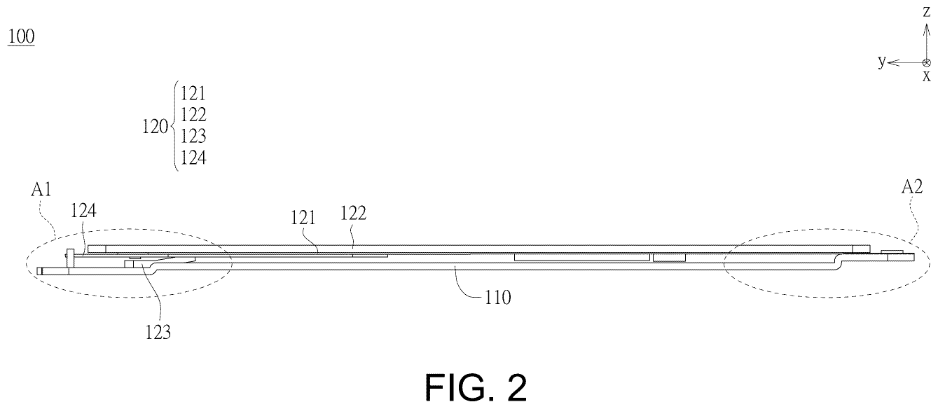

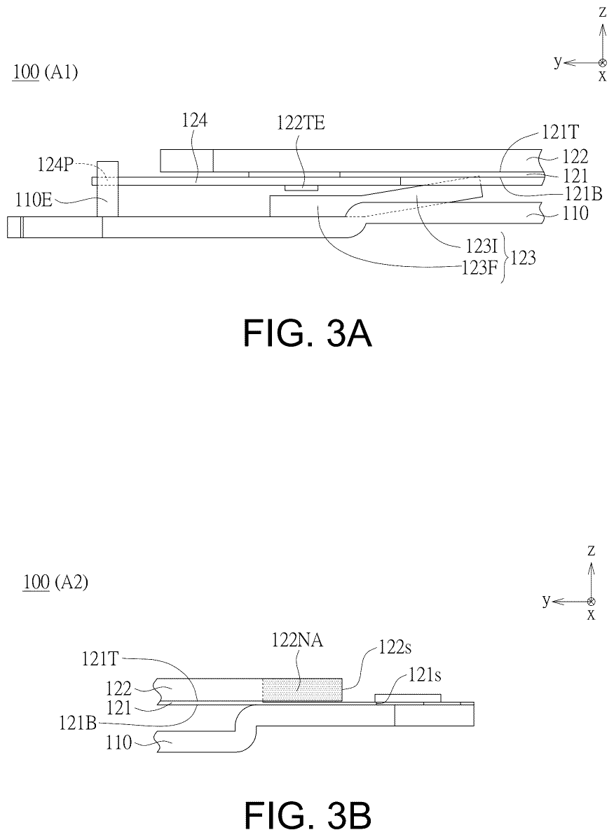

Refer to FIGS. 2 and 3A to 3B. FIG. 2 is a side view of the touch panel assembly 100 of FIG. 1. FIGS. 3A to 3B are enlarged side views of local areas A1 and A2 of the touch panel assembly 100 of FIG. 2.

The touch panel module 120 may comprise a flexible sheet component 121, a circuit board 122, a lever component 123 and a supporting component 124. The flexible sheet component 121, which can be realized by a Mylar double sided tape, has a top surface 121T and a bottom surface 121B opposite to each other. The circuit board 122, which can be realized by a printed circuit board (PCB), is adhered to the top surface 121T. The circuit board 122 has a trigger element 122TE, which can be realized by a metal dome used as a pressing switch.

The lever component 123, which can be realized by a metal component, is adhered to the bottom surface 121B. As illustrated in a side view, the lever component 123 has a flat portion 123F and an inclined portion 1231 interconnected with each other. As illustrated in a side view, the flat portion 123F and the inclined portion 1231 are not parallel to each other but form an angle instead. That is, the lever component 123 is a polyline component. The flat portion 123F is separated from the flexible sheet component 121 and the circuit board 122. The inclined portion 1231 is adhered to the bottom surface 121B. When the touch panel module 120 is not pressed, a gap is formed between the flat portion 123F and the trigger element 122TE of the circuit board 122. When the touch panel module 120 is pressed, the flat portion 123F and the trigger element 122TE come into contact and trigger a corresponding touch function.

The supporting component 124, which can be realized by a metal component, is adhered to the bottom surface 121B. The supporting component 124 has a protruding structure 124P, and the base 110 has an engaging structure 110E, so that the supporting component 124 can pass through the engaging structure 110E to be fixed on the base 110 through the protruding structure 124P, and that the touch panel module 120 and the base 110 can be firmly assembled. Besides, on the Y direction, the top edge 121S of the flexible sheet component 121 is opposite to a top edge 122S protruded from the circuit board 122. That is, the boundary of the flexible sheet component 121 is closer to the outside of the touch panel module 120 than the boundary of the circuit board 122.

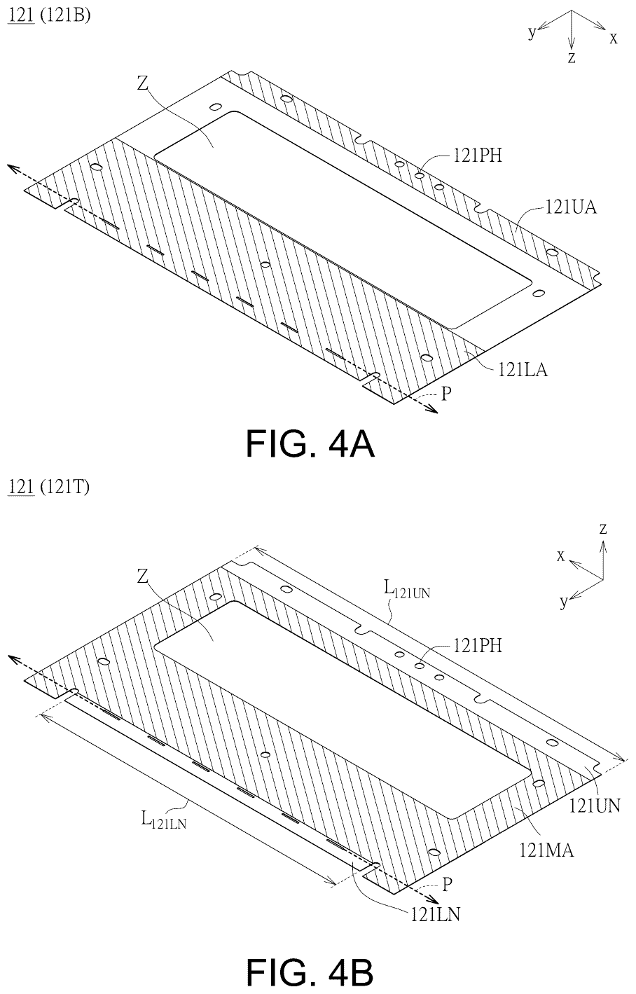

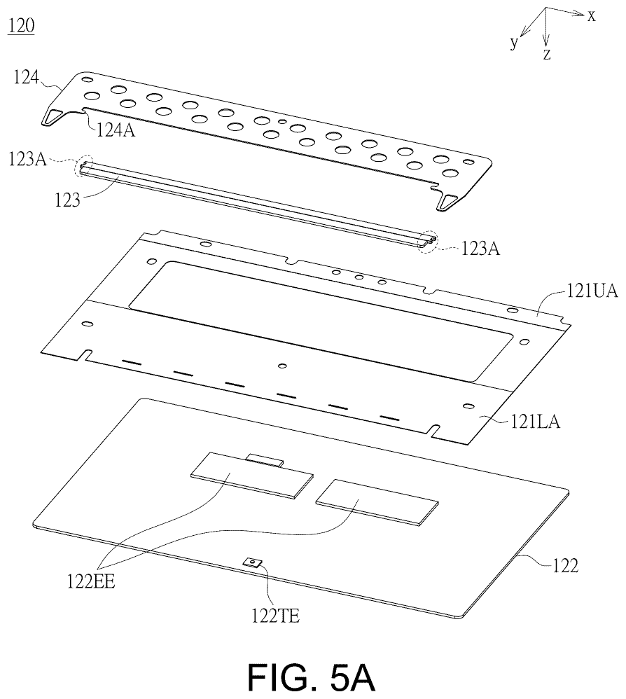

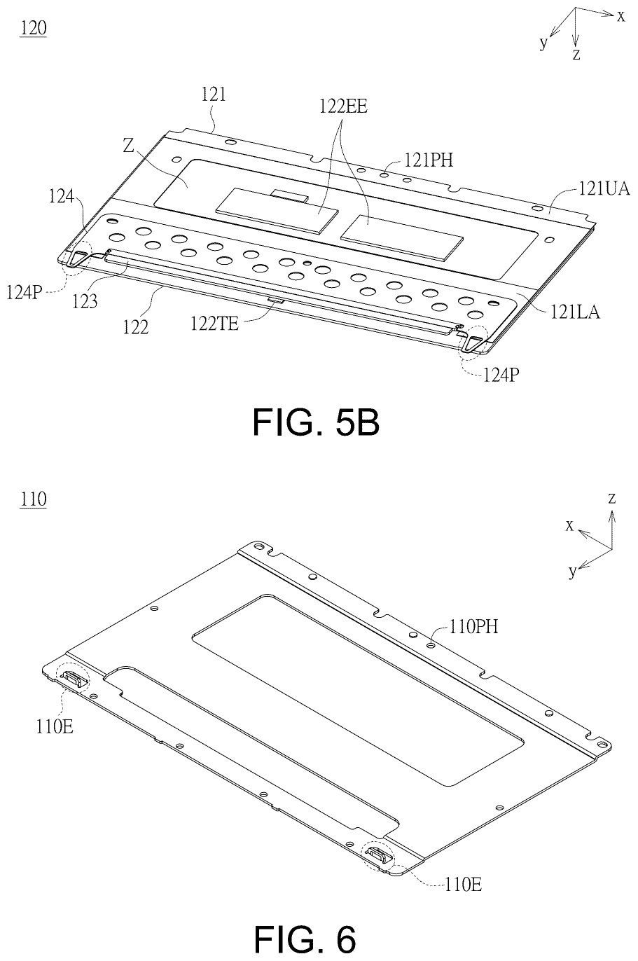

Refer to FIGS. 4A to 4B, 5A to 5B and 6. FIGS. 4A to 4B are schematic 3D diagrams of the flexible sheet component 121 of the touch panel module 120. FIG. 5A is an explosion diagram of the touch panel module 120 of the touch panel assembly 100 of FIG. 1. FIG. 5B is a schematic assembly diagram of the touch panel module 120 of the touch panel assembly 100 of FIG. 1. FIG. 6 is a schematic 3D diagram of the base 110 of the touch panel assembly 100 of FIG. 1. FIG. 4A illustrates the bottom surface 121B of the flexible sheet component 121. FIG. 4B illustrates the top surface 121T of the flexible sheet component 121.

The top surface 121T of the flexible sheet component 121 may have an upper non-adhesive portion 121UN, a middle adhesive portion 121MA (denoted by slashes) and a lower non-adhesive portion 121LN. The bottom surface 121B of the flexible sheet component 121 has an upper adhesive portion 121UA and a lower adhesive portion 121LA (both are denoted by slashes). The adhesive portion can be understood as a region with adhesivity; the non-adhesive portion can be understood as a region without adhesivity.

The base 110 is adhered to the upper adhesive portion 121UA of the bottom surface 121B. The circuit board 122 is adhered to the middle adhesive portion 121MA of the top surface 121T but not adhered to the upper non-adhesive portion 121UN of the top surface 121T. The lever component 123 and the supporting component 124 are adhered to the lower adhesive portion 121LA of the bottom surface 121B. The upper non-adhesive portion 121UN of the top surface 121T is at an opposite side to a position where the base 110 is adhered to the upper adhesive portion 121UA. The lower non-adhesive portion 121LN of the top surface 121T is at an opposite side to a position where the lever component 123 is adhered to the lower adhesive portion 121LA. The middle adhesive portion 121MA of the top surface 121T is at an opposite side to a position where the supporting component 124 is adhered to the lower adhesive portion 121LA. Besides, a hollowed region Z can be defined in the middle adhesive portion 121MA of the top surface 121. An electronic element 122EE of the circuit board 122 is disposed in the hollowed region Z.

The assembly process of the touch panel module 120 of the present embodiment is disclosed below. Firstly, the supporting component 124 is vertically (such as along the Z direction indicated in FIG. 5A) adhered to the lower adhesive portion 121LA of the bottom surface 121B of the flexible sheet component 121. The supporting component 124 can be designed to have a first positioning structure 124A. In the present embodiment, there are two first positioning structures 124A respectively formed on two sides of the bottom side of the supporting component 124. Correspondingly, the lever component 123 can be designed to have a second positioning structure 123A matching the first positioning structure 124A. In the present embodiment, there are two second positioning structures 123A respectively formed on two ends of the lever component 123. Illustratively but not restrictively, the first positioning structure 124A and the second positioning structure 123A can be designed to have male and female shapes matching each other.

After the assembly of the supporting component 124 is completed, the second positioning structure 123A can be aligned with the first positioning structure 124A, so that the lever component 123 can be adhered to the lower adhesive portion 121LA of the bottom surface 121B of the flexible sheet component 121. Specifically, the inclined portion 1231 of the lever component 123 is adhered to the lower adhesive portion 121LA, but the flat portion 123F is not adhered to the lower adhesive portion 121LA. As indicated in FIG. 5B, along the Y direction, the lever component 123 is located under the supporting component 124. In other words, the lever component 123 is received in the area defined by the inner edges of the supporting component 124.

After the assembly of the lever component 123 is completed, the assemblies of the flexible sheet component 121, the lever component 123 and the supporting component 124 are adhered to the circuit board 122. Specifically, the assemblies of the flexible sheet component 121, the lever component 123 and the supporting component 124 are vertically (such as along the Z direction as indicated in FIG. 5A) adhered to the circuit board 122 through the middle adhesive portion 121MA of the top surface 121T of the flexible sheet component 121. As indicated in FIG. 5B, the touch panel module 120 is formed.

After the assembly of the touch panel module 120 is completed, the touch panel module 120 is disposed on the base 110. As indicated in FIG. 5B, the flexible sheet component 121 can be designed to have a first perforation structure 121PH on the upper non-adhesive portion 121UN and the upper adhesive portion 121UA (that is, the top and bottom surfaces of the flexible sheet component 121). As indicated in FIG. 6, the base 110 can be designed to have a second perforation structure 110PH corresponding to the first perforation structure 121PH. Specifically, through the upper adhesive portion 121UA of the bottom surface 121B of the flexible sheet component 121, the upper adhesive portion 121UA faces the base 110, and an upper edge of the base 110 is adhered to the upper adhesive portion 121UA of the bottom surface 121B of the flexible sheet component 121 through the alignment between the first perforation structure 121PH and the second perforation structure 110PH. Regarding the fixation between a lower edge of the base 110 and the touch panel module 120, the protruding structure 124P of the supporting component 124 can pass through the engaging structure 110E of the base 110 so that the lower edge of the base 110 and the touch panel module 120 can be firmly fixed. Therefore, as indicated in FIG. 1, the touch panel assembly 100 is formed.

As described above, the lower non-adhesive portion 121LN of the top surface 121T is at an opposite side to a position where the inclined portion 1231 of the lever component 123 is adhered to the lower adhesive portion 121LA. Since the lower non-adhesive portion 121LN is not adhered to the circuit board 122, a pivot axis P is formed between the lower non-adhesive portion 121LN and the middle adhesive portion 121MA. The pivot axis P is a bendable cardinal axis formed at the junction between the adhesive region and the non-adhesive region of the same component. Thus, the flexible sheet component 121 allows the lever component 123 to swing along the pivot axis P to contact the trigger element 122TE. Specifically, when the lever component 123 swings along the pivot axis P, the inclined portion 1231 is adhered to the flexible sheet component 121 and used as a fixed end, and the flat portion 123F, being a movable end, can contact the trigger element 122TE to implement the touch function of the touch panel assembly 100.

In the extending direction of the pivot axis P (such as a direction parallel to the X direction as indicated in FIGS. 4A to 4B), the upper non-adhesive portion 121UN and the lower non-adhesive portion 121LN can have different lengths on the top surface 121T of the flexible sheet component 121. In the present embodiment, as indicated in FIG. 4B, the length L121UN of the upper non-adhesive portion 121UN is greater than the length L121LN of the lower non-adhesive portion 121LN. Since the circuit board 122 is only adhered to the middle adhesive portion 121MA of the top surface 121T of the flexible sheet component 121 but is not adhered to the upper non-adhesive portion 121UN, when the circuit board 122 is pressed, as indicated in FIG. 3B, the non-adhered part 122NA (denoted by meshes) of the circuit board 122 can reserve a deformation allowance for the circuit board 122, so that the junction between the circuit board 122 and the base 110 will not be bent and over-deformed.

According to the touch panel assembly disclosed in an embodiment of the present disclosure, a bendable pivot axis, formed between an adhesive region and a non-adhesive region on two opposite sides of the flexible sheet component and used as a cardinal axis, allows the lever component to swing so as to trigger the trigger element on the circuit board and implement the touch function of the touch panel assembly when the user presses the touch panel module. Through the design of the present disclosure, the function of the touch panel assembly can be achieved through a simple assembly of components without using the reciprocal structure and stopping structure commonly used in the field of touch panel. Thus, overall weight and thickness of the touch panel assembly can be reduced, lightweight design can be implemented, and production cost can be reduced.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A touch panel assembly, comprising:
a base; and
a touch panel module disposed on the base, wherein the touch panel module includes:
a flexible sheet component having a top surface and a bottom surface opposite to each other;
a circuit board adhered to a middle adhesive portion of the top surface, wherein the circuit board has a trigger element; and
a lever component adhered to a lower adhesive portion of the bottom surface;
wherein, a lower non-adhesive portion of the top surface is at an opposite side to a position where the lever component is adhered to the lower adhesive portion; a pivot axis is formed between the lower non-adhesive portion and the middle adhesive portion; and the flexible sheet component allows the lever component to swing along the pivot axis so as to contact the trigger element.

2. The touch panel assembly according to claim 1, wherein the touch panel module further includes:
a supporting component adhered to the lower adhesive portion of the bottom surface, wherein the middle adhesive portion of the top surface is at an opposite side to a position where the supporting component is adhered to the lower adhesive portion.

3. The touch panel assembly according to claim 2, wherein the supporting component has a first positioning structure; the lever component has a second positioning structure matching the first positioning structure.

4. The touch panel assembly according to claim 2, wherein the supporting component has a protruding structure; the base has an engaging structure; the supporting component passes through the engaging structure by means of the protruding structure to be fixed on the base.

5. The touch panel assembly according to claim 1, wherein the bottom surface of the flexible sheet component further has an upper adhesive portion; the base is adhered to the upper adhesive portion; an upper non-adhesive portion of the top surface of the flexible sheet component is at an opposite side to a position where the base is adhered to the upper adhesive portion; the circuit board is not adhered to the upper non-adhesive portion.

6. The touch panel assembly according to claim 5, wherein a top edge of the flexible sheet component is opposite to a top edge protruded from the circuit board; the flexible sheet component has a first perforation structure at the upper non-adhesive portion and the upper adhesive portion; the base has a second perforation structure corresponding to the first perforation structure.

7. The touch panel assembly according to claim 5, wherein the length of the upper non-adhesive portion of the top surface of the flexible sheet component along an extending direction of the pivot axis is different from the length of the lower non-adhesive portion.

8. The touch panel assembly according to claim 7, wherein the length of the upper non-adhesive portion is greater than that of the lower non-adhesive portion.

9. The touch panel assembly according to claim 1, wherein the lever component has a flat portion and an inclined portion interconnected to each other; the inclined portion is adhered to the lower adhesive portion of the bottom surface of the flexible sheet component; the flat portion is separated from the flexible sheet component and the circuit board; when the lever component swings along the pivot axis, the flat portion contacts the trigger element.

10. The touch panel assembly according to claim 1, wherein a hollowed region is defined in the middle adhesive portion of the top surface of the flexible sheet component; an electronic element of the circuit board is disposed in the hollowed region.
